(19) United States
(12) Patent Application Publication
(10) Pub. No.: US 2007/0083399 A1
(43) Pub. Date: Apr. 12, 2007

(54) Electronic funds transfer-based system and method for payment plans

(76) Inventor: Wayne A. Bryan, Richmond, VA (US)

Correspondence Address: MAIER & MAIER, PLLC, 128 N. PITT ST., SECOND FLOOR, ALEXANDRIA, VA, 22314, US

(21) Appl. No.: 11/592,212

(22) Filed: Nov. 3, 2006

Related U.S. Application Data
(63) Continuation-in-part of application No. 11/345,267, filed on Feb. 2, 2006.
(60) Provisional application No. 60/725,298, filed on Oct. 12, 2005.

(51) Int. Cl. G06Q 40/00

(52) U.S. Cl. 705/4; 705/40

(57) ABSTRACT

A system and method enabling medical providers to establish electronic funds transfer-based (EFT-based) payment plans. This can include a secure internet application for creating managing and tracking payment transactions and business processes required to effectively institute the payment plans and programs.

### PRIORITY

This application is a continuation-in-part which claims priority under 35 U.S.C. 120 to U.S. Nonprovisional patent application Ser. No. 11/345,267, filed Feb. 2, 2006, which in turn claims priority under 35 U.S.C. 119 to U.S. Provisional Patent Application No. 60/725,298, filed Oct. 12, 2005, the contents of both are hereby incorporated by reference in their entireties.

### FIELD

The present embodiments relate to electronic funds transfer-based (EFT-based) systems and methods for payment plans. More particularly, the present embodiments relate to EFT-based systems and methods for payment plans for use in the medical fields.

### BACKGROUND

In the health care field, expenses are affected in some manner by a third party who is separate from the patient and the medical provider. This third party can be any of a variety of entities, such as an insurance provider, an employer, or a state or federal government program or institution. This entity may handle all or some of the medical expenses and may further act as a conduit through which a patient pays for his or her medical expenses.

Due in part to these third parties, the financial responsibility of patients for medical expenses has been steadily increasing for several reasons. For insured patients who are responsible for paying a percentage of their medical expenses, the rise in costs increases the amount of the deductible they pay. Medical insurers are increasing deductibles for standard accounts and introducing new High Deductible Health Plans (HDHPs) for patients with Health Savings Accounts (HSAs).

Regardless of what type of, if any, insurance, patients may have, a medical provider may have to set up effective payment programs with their patients. Many of these programs involve payment over time, either directly to the medical provider or to a third party financial institution (e.g. banks, credit cards and financing agencies). While it is possible for a medical provider to check eligibility from an insurance payer and estimate a patient's monetary responsibilities, setting up financing requires an exact total. Because of the complexity of medical care, with multiple services delivered by multiple entities, the final balance is frequently unknown when the patient leaves the hospital. A further delay is added in the case of insured patients. Approximately 70% of those treated are insured patients, whose total responsibility is known only after the final balance is submitted to an insurance provider and one or more explanation of benefits (EOB) forms are received. The complete process may take several weeks or months.

A health savings account (HAS) is a tax-advantage medical savings account available to taxpayers in the United States. HSAs were established as part of the Medicare Prescription Drug, Improvement, and Modernization Act which was signed into law by President Bush on Dec. 8, 2003. These accounts are a component of consumer-driven health care plans. HSAs often are marketed as “alternative” to tradition health insurance as they are actually savings accounts (and can also be investment vehicles) instead of health insurance plans. In order to contribute to an HSA, the account owner must be enrolled in a high deductible health plan (HDHP).

HSA participants do not have to obtain advance approval from their HSA provider/trustee or their medical insurer in order to withdraw funds, and the funds are not subject to income taxation if made for qualified medical expenses including deductibles and coinsurance, as well as, many other expenses not covered under medical plans (e.g. dental, vision and chiropractic care).

Due to the rising cost of conventional health insurance, substantial political backing for consumer-directed health initiatives and financial attractiveness of tax-free saving vehicles, many expect that revenue from HSAs and their accompanying HDHPs will grow. Some predict that by 2010, HSAs/HDHPs will capture about ten percent of the health insurance market with averages balances of about $3,500. If this prediction is true, $75 billion of new money would need to be managed by 2010. Thus, people enrolled in HSAs/HDHPs may have an increasing interest in having their accounts managed effectively.

Yet, the growth of HSAs/HDHPs face numerous challenges. Prospective enrollees may be reluctant to take on the risk of greater out-of-pocket expenses leading to an increase chance in an inability to pay when their fund would be substantially below the maximum out-of-pocket costs. Funds fall well below the maximum out-of-pocket costs due to how HSAs are structured. Because a plan member's contributions must be scaled to the plan's deductible there is a period where the level of funds is far below the maximum out-of-pocket outlay. Notably, this situation is not limited to new HSAs/HDHPs, but occurs whenever the account is diminished. For example, from prior year illness or prior year family member expenses and the like.

High liquidity is another challenge associated with HSAS. Because money may need to be withdrawn from a HSA at any time with little notice, HSA plan administrators often invest heavily in vehicles with high liquidity, thus, restricting the range of investment vehicles because higher yield vehicles usually require longer or fixed-term commitments with penalties for early withdrawal. Also, due to plan members' control of whether and when to make payments from HSA accounts, providers face the same or greater difficulties in collections as with other patients. This difficulty arises partly because a reluctance to pay is at the heart of the cost-savings objectives of a consumer-directed health spending approach.

### SUMMARY

A system and method enabling hospitals, clinics, and other medical providers, as well as, any other person or entity handling financial matters on the behalf of such providers to establish electronic funds transfer-based (EFT-based) payment plans. This may include a secure internet application for creating, managing and tracking payment transactions and business processes required to effectively institute these programs.

In one embodiment, a method of scheduling payment to a medical service provider is disclosed. In this embodiment, whether a person receiving care has a HSA is determined. Then a financial obligation of that person can be established. This may be followed by the person and the service provider reaching an agreement regarding the amount and number of payments that the person may be required to submit to the service provider. This information may then be entered into a database which can be accessed by a person in a remote location. Additionally, the database may be accessed via an interface that allows the person to make and schedule payments as well as view some or all account information.

In another embodiment, a third party hosts an electronic funds transfer-based (EFT-based) payment program where payment agreements between, for example, a patient and a medical provider are stored in a database. The third party or any other party may effectuate payment on the obligation of a patient via an electronic funds transfer (EFT). The EFT may debit the health savings account (HSA) of the patient and deposit currency into an account held by the service provider.

### BRIEF DESCRIPTION OF THE DRAWINGS

FIG. 1 is an exemplary flow chart showing an existing payment process for use with HSAs.

FIG. 2 is an exemplary flow chart showing a point of service electronic funds transfer-based (EFT-based) medical payment method for use with HSAs.

FIG. 3 is another exemplary flow chart showing a point of service electronic funds transfer-based (EFT-based) medical payment method for use with HSAs.

FIG. 4 is another exemplary flow chart showing a point of service electronic funds transfer-based (EFT-based) medical payment method for use with HSAs.

FIG. 5 is an exemplary flow chart showing an electronic funds transfer-based (EFT-based) medical payment method for use with HSAs.

FIG. 6 is another exemplary flow chart showing an electronic funds transfer-based (EFT-based) medical payment method for use with HSAs.

FIG. 7 is yet another exemplary flow chart showing a point of service electronic funds transfer-based (EFT-based) medical payment method for use with HSAs.

FIG. 8 is an exemplary figure showing a login screen to a graphical (i.e. web-based) user interface.

FIG. 9 is an exemplary figure showing a graphical (i.e. web-based) user interface.

FIG. 10 is another exemplary figure showing a graphical (i.e. web-based) user interface.

FIG. 11 is yet another exemplary figure showing a graphical (i.e. web-based) user interface.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follow.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation. Embodiments of the systems and methods for establishing electronic funds transfer-based payment plans according to the present invention may be located at the offices of a provider in order to allow a technician to create and submit a payment agreement to a database. As used herein, electronic funds transfer or “EFT” describes the exchange of an electronic payment using electronic communication. Also, as used herein, the term “service provider,” “medical provider” or “provider” is to be broadly construed to include any person, entity, financial institution and the like that may handle, process, or enter into payment agreements themselves or on behalf of another or handle, process, schedule, or collect payments themselves or on behalf of another. Additionally, the term “medical technician” is to be construed as any person or entity that may engage in the above activities on behalf of a “service provider” and any claims that recite acts, operations or processes conducted by a “service provider” are to be construed to extend to the same acts, operations, or processes conducted by “medical technicians,” as well.

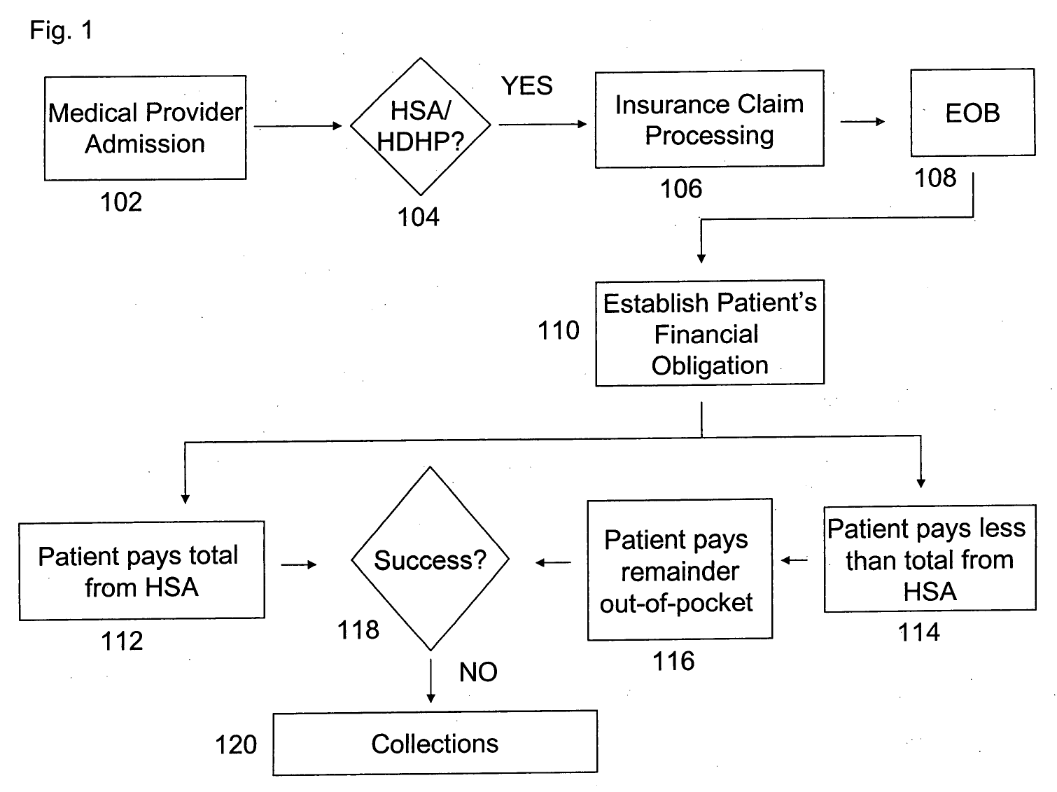

Exemplary embodiments of the present invention may provide several key benefits to HSA/HDHP plans, including: mitigating risk of financial exposure for plan members before accounts are funded to deductible levels; supporting greater choice of fund investment options by reducing the need for liquidity; and providing a lower cost alternative to prior art debit cards. In regard to financial exposure of plan members, one embodiment of the present invention allows them to pay their medical costs over time and schedule payments, for example, to take advantage of their tax-free contributions to their HSAs without affecting the already invested principal. Scheduled recurring payments could reduce the need for immediate liquidity and allow, for example, HSA administrators greater flexibility in investment vehicle choice. For providers, the plan provides a dependable low-maintenance revenue stream. Additionally, the electronic funds transfer fee can be established at a lower-cost flat rate unlike current debit card transaction fees that are often based (e.g. a percentage of) on the total amount transacted. Thus, higher payment amounts may benefit from a lower flat rate. For illustrative purposes—in a non-limiting manner—FIG. 1 of the present disclosure shows an exemplary flow chart of an existing HSA/HDHP-based financing process.

The Automated Clearing House (ACH) Network is regarded by some as a highly reliable and efficient nationwide batch-oriented EFT system governed by the National Automated Clearing House Association (NACHA) OPERATING RULES which may provide for the interbank clearing of electronic payments for participating depository financial institutions. The Federal Reserve and Electronic Payments Network may act as ACH Operators, i.e. central clearing facilities through which financial institutions may transmit or receive ACH entries.

For further information regarding ACH rules and agreements, see The Federal Reserve Uniform Operating Circular, Regulation E and Official Staff Commentary, Electronic Funds Transfer Act, Federal Tax Deposit Payments and Title 31 CFR Parts 208 and 210, which is hereby incorporated by reference in its entirety. Additionally, see the 2006 ACH Operating Rules and Guidelines, published by the NACHA, which is also hereby incorporated by reference in its entirety.

Exemplary embodiments of the invention include or are incorporated in computer-readable media having computer-executable instructions or data structures stored thereon. Examples of computer-readable media include RAM, ROM, EEPROM, CD-ROM or other optical disk storage, magnetic disk storage or other magnetic storage devices, or any other medium capable of storing instructions or data structures and capable of being accessed by a general purpose or special purpose computer. Computer-readable media also encompasses combinations of the foregoing structures. Computer-executable instructions comprise, for example, instructions and data that cause a general purpose computer, special purpose computer, or special purpose processing device to execute a certain function or group of functions. The computer-executable instructions and associated data structures represent an example of program code means for executing the steps of the invention disclosed herein.

Further exemplary embodiments include or incorporate at least one database which may store software, descriptive data (e.g. financial account information, balance information, payment information, payment timing information, payment tracking information and personal information), system data, digital images and any other data item required by the other components necessary to effectuate any embodiment of the present system and method known to one having ordinary skill in the art. The databases may be provided, for example, as a database management system (DDMS), and object-oriented database management system (ODBMS), a relational database management system (e.g. DB2, ACCESS, etc.), a file system or another conventional database package. Thus, the databases can be implemented using object-oriented technology, via text files or any other technology for implementing a database known to one having ordinary skill in the art. Further, the databases can be accessed via a Structure Query Language (SQL) or other tools known to one having ordinary skill in the art.

At least one exemplary embodiment of the invention further extends to computer systems for interactively scheduling and paying medical costs. Those skilled in the art will understand that the invention may be practiced in computing environments with many types of computer system configurations, including, but not limited to, personal computers, multi-processor systems, network PCs, minicomputers, mainframe computers, portable electronic devices, personal digital assistants (PDAs), cellular or satellite phones, or any other phone systems and electronic devices known to one having ordinary skill in the art.

At least one embodiment of the invention will be described herein in reference to a distributed computing environment, such as the Internet, where tasks are performed by remote processing devices that are linked through a communications network. While at least one embodiment is described herein in the context of the Internet, those skilled in the art will appreciate that other communications systems can be used, such as direct dial communication over public or private telephone lines, a dedicated wide area network, or the like. In the distributed computing environment, computer-executable instructions and program modules for performing the features of the invention may be located in both local and remote memory storage devices.

The Internet comprises a vast number of computers and computer networks that are interconnected through communication links. The interconnected computers exchange information using various services, such as electronic mail, Gopher, and the World Wide Web (WWW). For example, the WWW service allows a server computer system (i.e. Web server or Web site) to send graphical Web pages of information to a remote client computer system. The remote client computer system can then display the Web pages. Each resource (e.g. computer or Web page) of the WWW is uniquely identifiable by a Uniform Resource Locator (URL). To view a specific Web page, a client computer system specifies the URL for that Web page in a request (e.g. a HyperText Transfer Protocol (HTTP) request). The request is forwarded to the Web server that supports that Web page. When that Web server receives the request, it sends that Web page to the client computer system. When the client computer system receives that Web page, it typically displays the Web page using a browser. A browser is a special-purpose application program that effects the requesting of Web pages and the displaying of Web pages.

Web pages are typically defined using HyperText Markup Language (HTML). HTML provides a standard set of tags that define how a Web page is to be displayed. When a user indicates to the browser to display a Web page, the browser sends a request to the server computer system to transfer to the client computer system an HTML document that defines the Web page. When the requested HTML document is received by the client computer system, the browser displays the Web page as defined by the HTML document. The HTML document contains various tags that control the displaying of text, graphics, controls, and other features. The HTML document may contain URLs of other Web pages available on that server computer system or other server computer systems.

Referring generally to each of the embodiments described below, the payment plans and financial transactions in those embodiments may be monitored in any of a variety of manners. In one embodiment, a secure internet tool for creating, managing and tracking payment transactions and business processes that are necessary to effectively institute the payment plans and programs may be used. The internet tool may be such that it utilizes any of a variety of other internet tools, software and applications. See Preston Gralla, How the Internet Works, Ziff-Davis Press (1996), which is hereby incorporated by reference into this patent application. This tool can be such that it may be accessed by a user with access to the internet, regardless of location, through the use of any of a variety of secure access methods, such as entering a user name and password. In a further embodiment of the invention described generally below, the secure internet tool may have the necessary steps and questions from any or all of these exemplary embodiment and figures, allowing a service provider or medical provider and a patient seeking to plan the payment of their treatment to set up a payment plan.

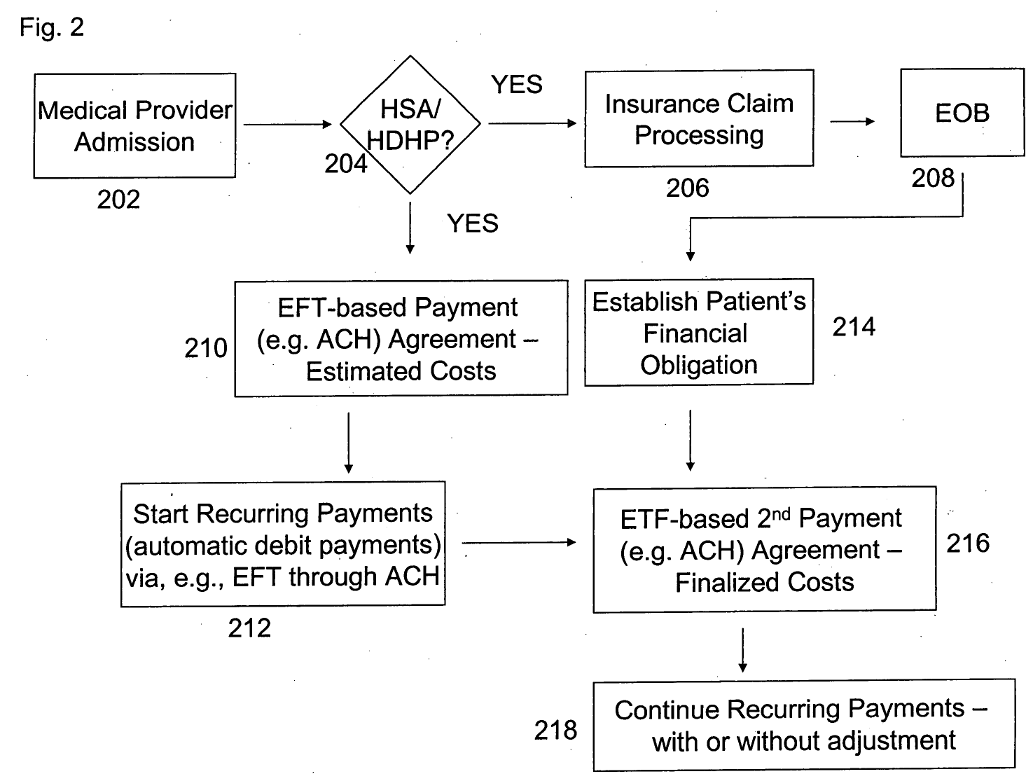

FIG. 2 is a flowchart showing one exemplary embodiment of the invention, wherein an electronic funds transfer-based (EFT-based) medical payment plan may be initiated at the point of service. The point of service may be the location where medical services are provided, such as a hospital, or any other location. Generally, the payments made pursuant to such a plan can begin based on estimating total costs, with the ability to modify/revise or replace the agreement when final costs are known.

First, at step 202—the point of service—a medical technician or someone in financial counseling for the medical provider determines whether or not a particular patient is insured and whether they have a HSA in step 204. If they have a HSA and HDHP, processing the insurance claim(s) begins at step 206. Next, at step 208, for the patient having a HSA and HDHP, an explanation of benefits (EOB) can occur. The EOB is a summary that the health plan can supply to both the medical provider and the insured that outlines all of the medical expenses and services claimed against the plan and information about the patient's financial responsibility. It may provide, for example, the date of service, the type of medical care provided, the amount of services that are covered and the amount of the charges that are the patient's responsibility.

Further, until a patient receives the EOB, the amount of their financial responsibility may not be fixed. It may take some amount of time to assemble and confirm the information required, so there may be a delay between the time of the service delivery and receipt of the EOB. The treatment is often completed and the patient may have already been discharged by the time the EOB is received by the patient.

During step 206, the insurance claim processing leading to a EOB at step 208 or sometime after receipt of the EOB by the patient and/or medical provider at step 208 (but before the patient's financial obligation may be established in step 214), a patient and the provider can agree to a first payment plan (e.g. EFT-based payment agreement), which may be in the form of a signed ACH agreement, in step 210. In step 210, the total amount that the patient will pay for the treatment may be based on an estimate determined by the service provider and can be based on any of a variety of factors. Step 210, for example, may be utilized by a patient before treatment is finished, i.e. for ongoing treatments, or when the total cost of the treatment is unknown at the time treatment begins. The EFT payment agreement of step 210 may call for recurring payments that may be negotiated on such factors as the estimated total cost of treatment provided by the medical provider, the available (e.g. high liquidity) funds in the patient's HSA, the amount and timing of the patient's pre-tax and/or taxed contributions to the HSA and any other such relevant financial information known to one having ordinary skill in the art. Then, in step 212 the patient may start making recurring payments (e.g. via an electronic funds transfer) before or after the receipt of the EOB in step 208 by the patient and/or the medical provider.

Upon the receipt of the EOB in step 208, the medical provider can establish and/or finalize a patient's total financial obligation at step 214. The patient may then enter into a second (i.e. revised) payment plan (e.g. EFT-based payment plan), at step 216, which may be in the form of an ACH signed agreement similar to the first. The agreement of step 216 may be sent (e.g. electronically or by mail) to the patient if treatment has ended or also be capable of being accessed remotely after it is stored in a database. Thus, the second payment agreement of step 216 may call for recurring payments that may be renegotiated on such factors as the finalized total cost of treatment provided by the medical provider, the available (e.g. high liquidity) funds in the patient's HSA, the amount and timing of the patient's pre-tax and/or taxed contributions to the HSA and any other such relevant financial information known to one having ordinary skill in the art. Next, in step 218, payments may continue according to the second payment agreement of step 216 in furtherance of satisfying the total obligation of step 214.

Alternatively, a second exemplary embodiment is shown, wherein recurring payments are not initiated after the first payment agreement as in step 212 of FIG. 2. Rather, in step 312, payments may be initiated after establishing the patient's finalized total financial obligation in step 314 which may or may not be modified/revised by a second payment agreement in step 316.

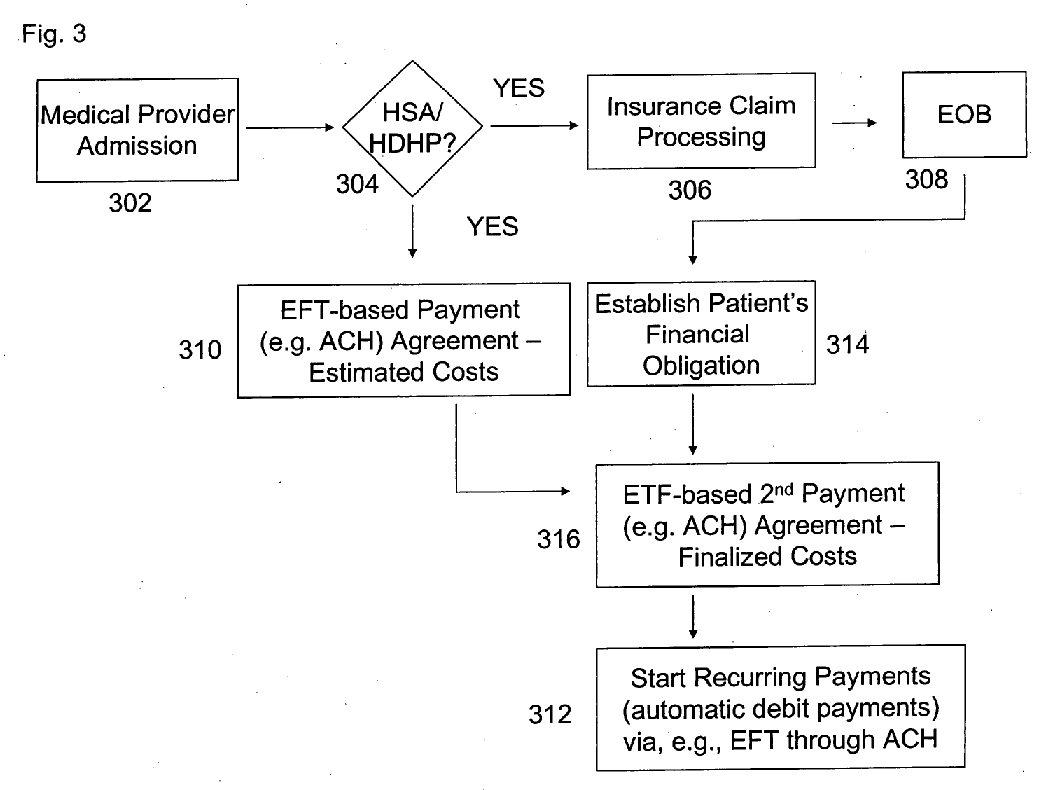

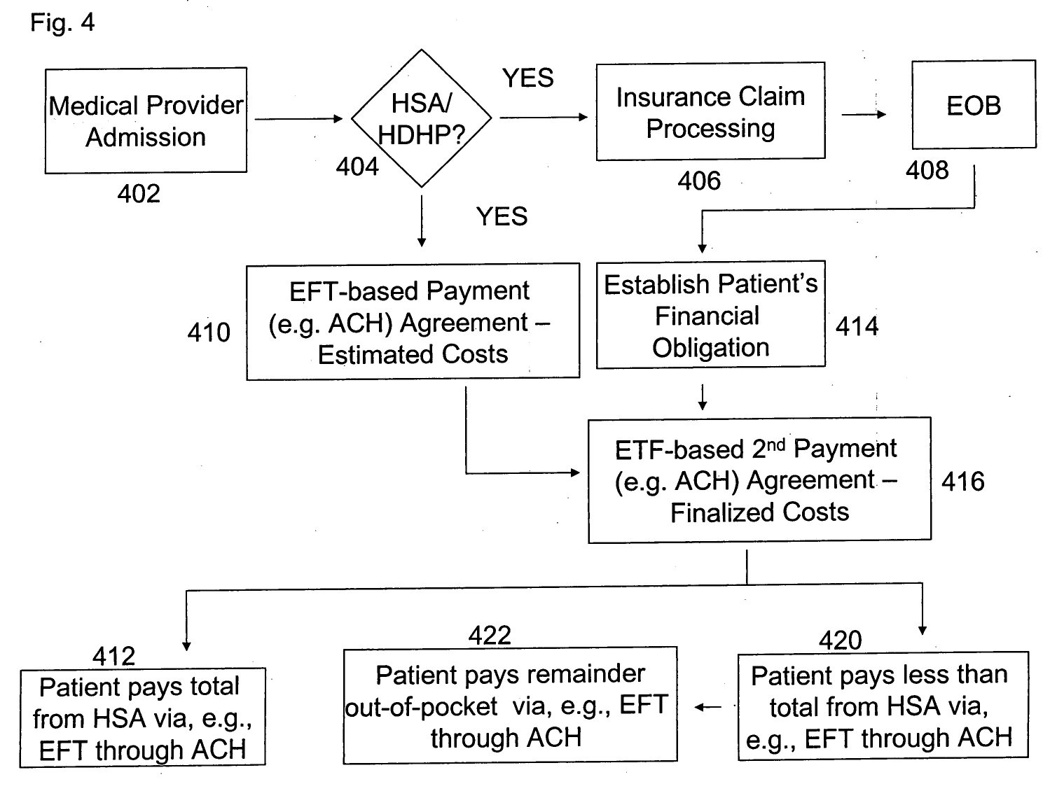

FIG. 4 is a flowchart showing another exemplary embodiment of the invention, wherein an electronic funds transfer-based (EFT-based) medical payment plan may be initiated at the point of service. As in FIG. 2 and 3, a person having a HSA will have their HDHP insurance claim processed in step 406 and an explanation of benefits (EOB) can be presented in step 408, prior to establishing the remaining financial obligation, if any, of the patient in step 414. Likewise, as shown in FIGS. 2 and 3, the patient and the provider can then establish the first EFT-based payment plan in step 410 based on estimated medical costs. However, the first payment plan in step 410 may not call for recurring payments. In step 414 the patient's exact financial obligation may be determined and a second EFT-based payment plan may be signed in step 416 reflecting the cost determination of step 414. Next, in step 412, the patient can send full payment via an electronic funds transfer (EFT) from the patient's HSA. Alternatively, in step 420 the patient may send partial payment via an EFT from the patient's HSA. Optionally, in step 422 the patient may make an additional payment(s), for example, from the same or another HSA, as well as, any other account capable of being electronically debited in furtherance of satisfying the total obligation known to one having ordinary skill in the art.

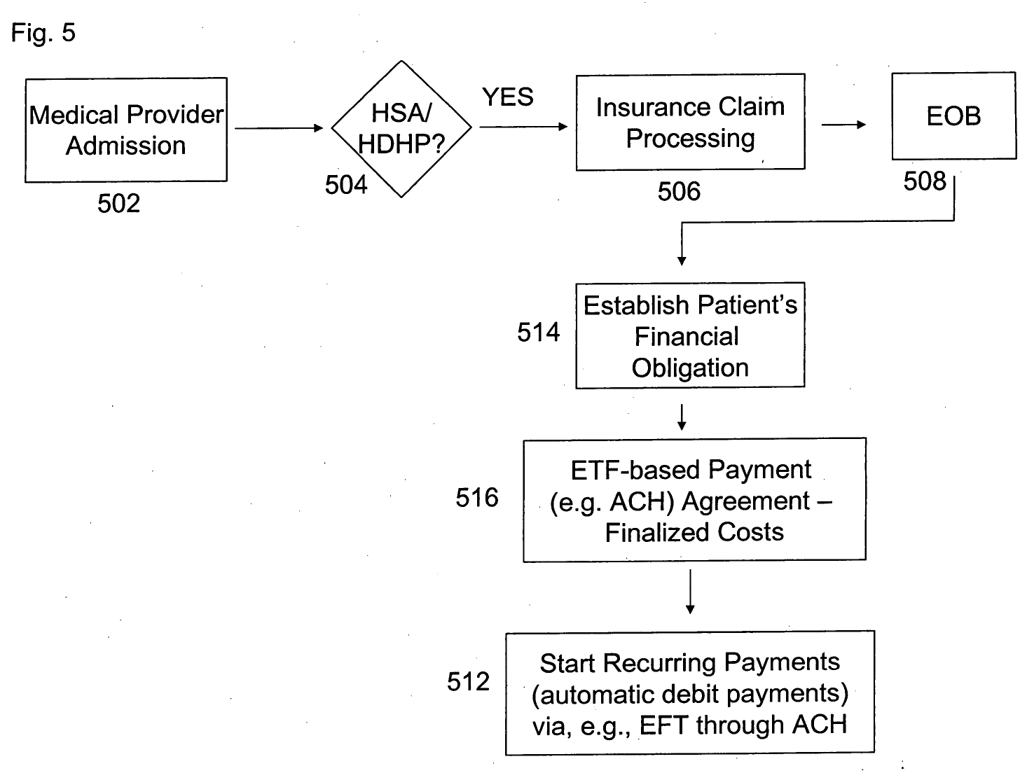

In yet another exemplary embodiment, as shown in the flowchart of FIG. 5, a service provider in step 502 determines whether or not a particular patient is insured and whether they have a HSA at step 504. If they have a HSA and HDHP, processing the insurance claim(s) can begin at step 506. Next, in step 508 an explanation of benefits (EOB) can occur. Upon the receipt of the EOB of step 508, the provider can establish and/or finalize a patient's total financial obligation in step 514. In step 516, the patient may then enter into a payment plan (e.g. EFT-based payment plan), where it may be in the form of an ACH signed agreement. Then, in step 512 the patient may pay recurring payments by automatic debit payments (e.g. via an electronic funds transfer (EFT)) until the total obligation of step 514 is satisfied.

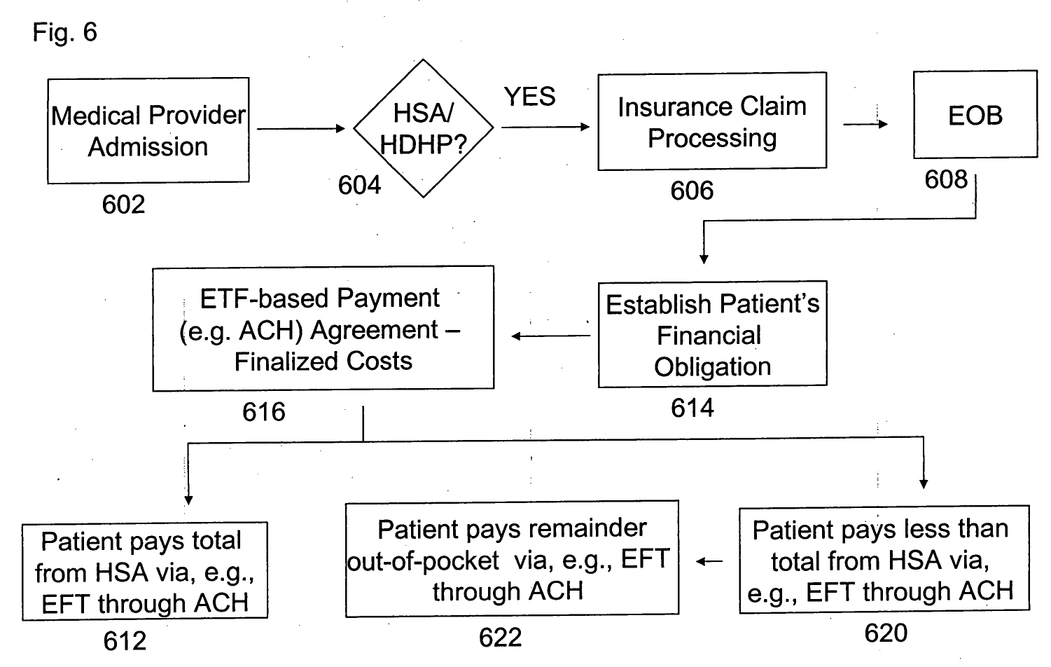

Alternatively, as shown by a further exemplary embodiment in the flow chart of FIG. 6, the patient in step 620 may send partial payment (e.g. via an EFT) from the patient's HSA according to the payment plant of step 616. Optionally, in step 622 the patient may make an additional payment(s), for example, from the same or another HSA, as well as, any other account capable of being electronically debited in furtherance of satisfying the total obligation of step 614.

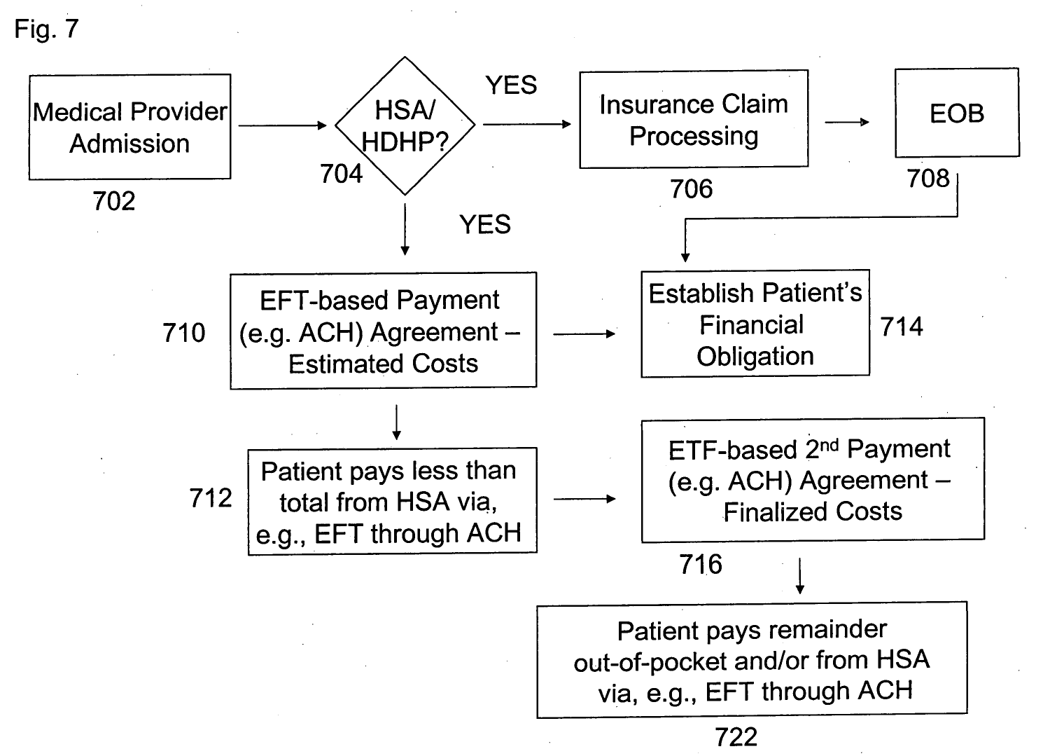

FIG. 7 is a flowchart showing another exemplary embodiment of the invention, wherein an electronic funds transfer-based (EFT-based) medical payment plan may be initiated at the point of service. As in FIGS. 2, 3 and 4, a person having a HSA will have their HDHP insurance claim processed in step 706 and an explanation of benefits (EOB) can be presented in step 708, prior to possibly establishing the remaining financial obligation, if any, of the patient in step 714. Likewise, as shown in FIGS. 2, 3 and 4, the patient and the provider can then establish the first EFT-based payment plan in step 710 based on estimating medical costs. However, the first payment plan in step 710 may not call for recurring payments. In step 712 the patient can send partial payment via an EFT from the patient's HSA according to the payment plant of step 710. Upon the receipt of the EOB in step 708, the medical provider can establish and/or finalize a patient's total financial obligation at step 714. The patient may then enter into a second (i.e. revised) payment plan at step 716 (e.g. ETF payment plan), which may be in the form of an ACH signed agreement, similar to the first. Optionally, in step 722 the patient may make an additional payment(s), for example, from the same or another HSA, as well as, any other account known to one baving ordinary skill capable of being electronically debited in furtherance of satisfying the total obligation of step 714.

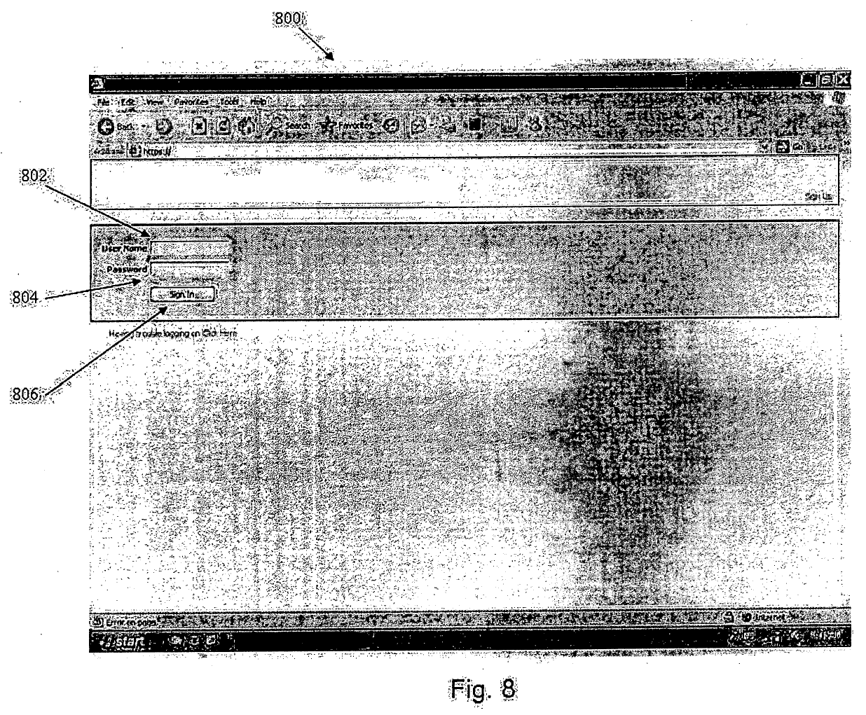

In yet another embodiment, an electronic funds transfer-based (EFT-based) medical payment system and method may have a variety of components, including a web-based graphical user interface, a server-based application, a relational database information repository and a supporting business process and resources. Exemplary figures depicting screen shots of a web-based interface are shown in FIGS. 8-11. Further, this system may use any type of database architecture or database software, for example Microsoft Access®, Microsoft SQL Server®, Oracle®, Sybase®, open source, etc., as well as any development language, for example including but not limited Java, EJB, Microsoft Visual Basic©, Microsoft C#® Microsoft VB.Net®, C++, etc. Additionally, any of a variety of Internet architectures, such as ASP, JSP, Web Services, Microsoft SPS® and other portal technologies and any available network/operating system platforms, for example Microsoft XP/XP Professional®, Unix, Linux, Sun, etc. may be utilized.

In FIG. 8, an exemplary interface for an EFT-based system and method is shown. Interface 800 can include data entry fields 802 and 804 for the entry of a user name and a password, respectively. Additionally, button 806, which may be marked “Sign In”, may be disposed on the interface 800 in such a manner as to allow a user to select or click the button in order to process the entered user name and password. Interface 800 may be accessed, for example, by any computer with access to the Internet. Additionally, interface 800 may be displayed on any of a variety of web browsers or internet-browsing programs.

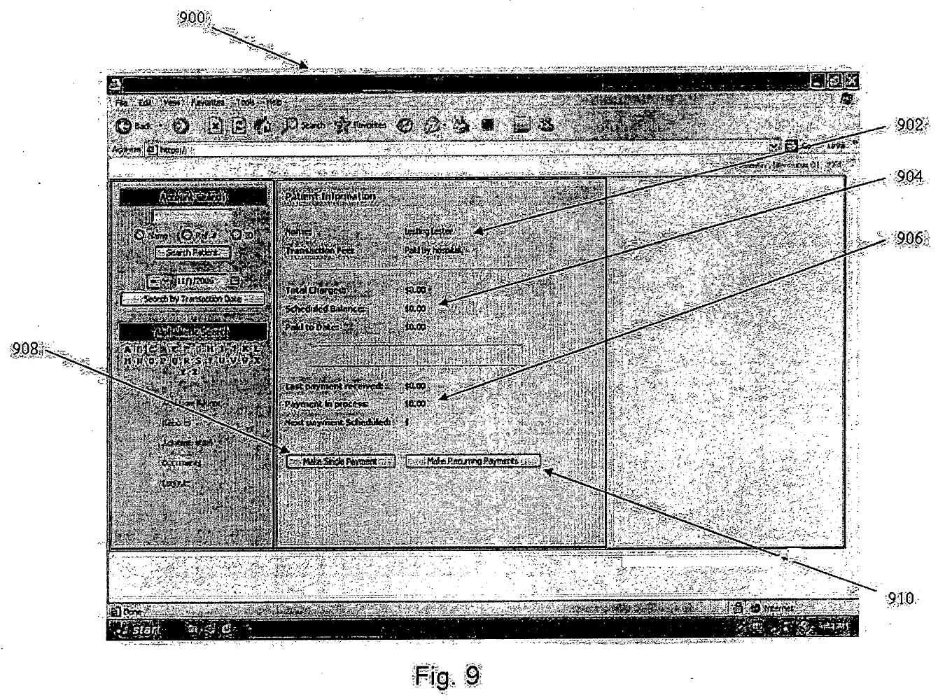

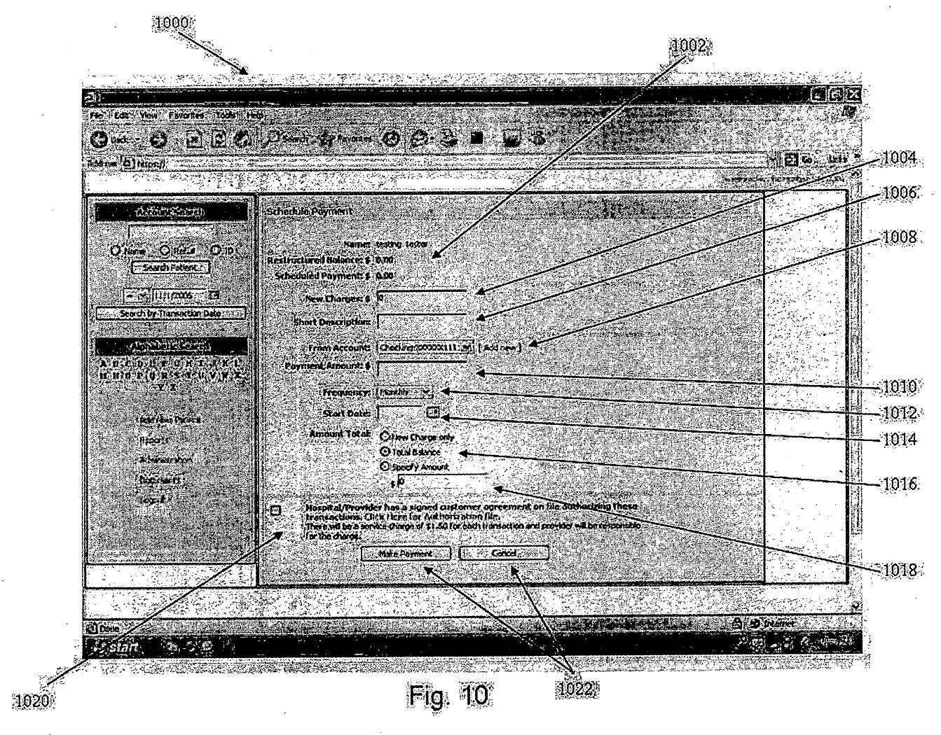

FIG. 9 shows another exemplary embodiment of an EFT program. In this embodiment, interface 900 can be used to access account information, for example, after securely logging in, that may include a data field 902 showing an account holder's name and what party is responsible for paying the electronic funds transfer transaction fee. Data field 904 may then be used to show the total amount charged to a user, the scheduled balance and the total amount paid to date by the user. Field 906 may show account payment info, such as when the last payment was received, the amount of a current payment that is being processed and the date of the next scheduled payment. Finally, buttons 908 and 910 may be disposed on a portion of interface 900 that allow a user to access additional interfaces (e.g. similar to interface 1000 of FIG. 10 described below) to make a single payment and set up recurring payments, respectively.

Further, FIG. 10 shows another exemplary embodiment of the present invention. This embodiment includes interface 1000 that a user or patient may access in order to make payments and schedule, for example, recurring payments from their account. Interface 1000 may include a data field 1002 showing an account holder's name, the restructured balance and the amount of a scheduled payment. Additionally, interface 1000 may include fields 1004 and 1006, which can show the amount of new charges and a short description thereof, respectively. Further, drop down menu 1008 may show a list of accounts that a user may draw the funds from to make a payment. Field 1010 can be used to enter the amount of a payment to be made, and drop down menu 1012 may be used to select the frequency with which a user desires to make a recurring payment. This menu can include, for example, weekly, bi-weekly, or monthly frequencies. Field 1014 may then be used by a user to select a date for recurring payments to begin or, alternatively, a date on which to make a specific, one-time payment. Section 1016 can allow a user to select the duration of.their payments, i.e. entering “total balance” will schedule recurring payments until the full balance of the account is paid in full. Field 1018 may be used to display the calculated total amount of payments to be made based on the factors entered. Section 1020 may include a disclaimer that a user needs to read and a check box that must be checked in order to proceed. For example, the disclaimer may require that the provider has a signed payment agreement on file and could additionally provide a hyperlink to an electronic copy of such an agreement or an authorization file. Finally, buttons 1022 may be used to either submit a payment or payment schedule or to cancel the entries in above fields and send the user to a different screen or interface.

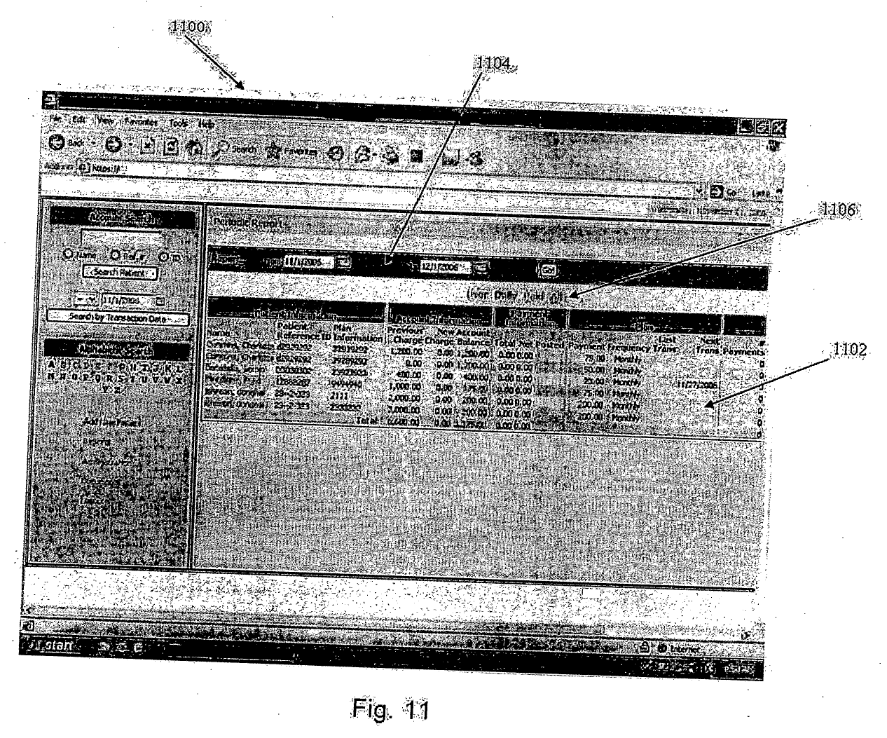

In further exemplary embodiments, one of which is shown in FIG. 11, a variety of data may be accessed after a user, such as a medical technician, logs into the program using interface 1100. In FIG. 11, personal and financial data 1102 may be displayed in table form. Data 1102 may include any of a variety of types of data including, for example, patient information (e.g. the patient's name, the provider's alphanumeric patient reference ID, alphanumeric plan information, etc.), account information (e.g. previous charge, new charge, account balance, etc.) payment information (e.g. total, net, posted, etc.), payment plan information (e.g. payment amount, frequency, last transaction, next transaction, etc.), account activity information (e.g. number of payments, net payment amount to date, missed payments, unscheduled payments, adjustments, etc.) and any other relevant personal or financial data. Personal and financial data 902 may be tailored by a user using toolbar 1104, which may allow for the sorting of the data by specific dates. Further, the program can include a toolbar 1106, which may allow a user to view, for example, summary for one patient, a daily summary of the accounts, a list of the paid transactions or a list of all transactions.

In a yet another embodiment, a web-based interface may allow users and medical providers/technicians (e.g. medical administrators, management and support staff) to enter, access and modify data used in the creation, maintenance and management of electronic funds transfer-based (EFT-based) payment programs.

The web-based interface can allow user to perform a variety of tasks, such as entering or modifying patient data, such as detailed demographic information and provider-designated patient identification numbers. The interface could also allow users to enter or modify bank account information, such as account type, routing number, account number, account nickname, etc. Users may also set up or modify recurring payment programs through the interface, including recurring payment amounts and schedules. Further, through the interface, the users may modify existing programs and payments, such as including, skipping or rescheduling individual payments, marking payments as paid and removing them from the program balance, or removing payments from the schedule without removing them from the program balance. Additionally, users may also access detailed reports and other information about payment program status, such as transactions scheduled, pending and completed, failed transactions, program balances and other detailed historical information through the interface. Further, the interface can allow users to access supporting documentation, such as required agreements or legal documentation, program explanations and marketing materials, scripts to guide patient interactions, online training tutorials, and other information that may make the program easier to explain and use.

In a further embodiment, the medical provider's staff responsible for administering the electronic funds transfer system may use the interface to add or modify system users, such as including setting up user names and passwords, and disabling accounts.

Additionally, the interface may allow the electronic funds transfer system management and support to add, modify, enable and disable new provider organizations. (Although new providers may have the ability to enter their own information into the interface, only the management or other authorized parties will have the ability to enable accounts.) Also, management may be able to access detailed reports and other information about the program as a whole, such as scheduled, pending, completed and failed transactions, program balances and other detailed historical information. In addition, management may also be able to identify and resolve issues with specific transactions and program functionality.

Also, a server-based application can support the functionality accessed through the user interfaces. This application may have programming code components implemented on an n-tier architecture. This code can encapsulate business rules, data input/output and transaction processes. It may also create the file required for the Federal Reserve ACH transactions as well as receiving and processing information from the ACH and banking processes.

Further, information can be tracked and stored in a relational database system. This can allow all levels of users to access detailed reports and conduct sophisticated analytics of the data, including, for example, transaction forecasts and history, individual user effectiveness and derived best practices.

Business processes and resources that may be implemented to use the system may be provided online and offline in printed and electronic formats. These can include methods and best practices for setting up the system in provider environments to take advantage of its unique capabilities at point of service and additional methods and best practices for payment plan conversion and collection applications. Further, detailed patient interaction scripts, incorporation the best ways of explaining the program to prospective participants, anticipated concerns and objections and related answers may be used. Also, methods and best practices for managing the system, increasing amounts collected and motivating relevant staff members may be implemented. Further, performance measurements and benchmarks, allowing providers to determine how their use of the system compares with similar organizations can be used with the system.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art. For example, although the preferred embodiments described above largely contemplate and describe payments electronically transferred from a HSA account, those skilled in the art would recognize that one-time and recurring (whether or not the same amount each period) payments may also be electronically transferred from any type of account (e.g. checking, savings or brokerage) with such capability.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of scheduling payment, comprising:
determining if a person has a health savings account (HSA);
establishing a financial obligation for the person;
creating a payment agreement between the person and a service provider to make payments on the financial obligation to the service provider; and
entering an agreement data into a database.

2. The method of claim 1, further comprising:
revising the financial obligation at the completion of the medical care.

3. The method of claim 1, further comprising:
having the payments on the financial obligation begin prior to the completion of the medical care.

4. The method of claim 1, further comprising:
receiving at least one payment via an electronic funds transfer (EFT).

5. The method of claim 1, wherein the database that the agreement data is entered into may be accessed remotely.

6. The method of claim 1, wherein the database that the agreement data is entered into may be accessed via the Internet.

7. The method of claim 1, wherein the database that the agreement data is entered into houses additional information about the person entering the agreement.

8. The method of claim 1, wherein the database that the agreement is entered into includes financial account information, balance information, payment information, payment timing information, payment tracking information and personal information.

9. The method of claim 1, wherein the payment agreement is an automated clearing house (ACH) agreement.

10. A system for processing fees, comprising:
accessing data of a person receiving care admitted to a medical provider;
establishing a financial obligation that the person is responsible for;
entering the person receiving the care into an agreement providing for at least one payment;
storing an agreement data in a database; and
receiving at least one payment on the financial obligation from a health savings account (HSA).

11. The system of claim 10, wherein the agreement is an automated clearing house (ACH) agreement.

12. The system of claim 10, wherein the receiving of at least one payment is via an electronic funds transfer (EFT).

13. The system of claim 10, wherein the database can be accessed through a graphical user interface accessible via the Internet.

14. The system of claim 10, wherein the database further houses financial and personal information of the person receiving care.

15. The system of claim 14, wherein the person receiving care can view and alter their financial and personal information by accessing the database.

16. The system of claim 15, wherein the person receiving care may make payments, schedule payments, alter payments and track payments by accessing the database.

17. The system of claim 10, wherein the financial obligation is determined when the person is receiving the care and adjusted after the person receives the care.

18. The system of claim 10, wherein the person does not interact with the care facility after they receive the care.

19. The system of claim 10, wherein the database may be accessed by care facility administrators to view the account information of a person.

20. A service cost payment system, comprising:
a step for determining if a person has a health savings account (HSA);
a step for assigning a total cost obligation to the person;
a step for having the person sign a payment agreement;
a step for storing an agreement data into a database; and
a graphical user interface from which the person can schedule and make payments against the total cost obligation.

21. A payment system to a service provider, comprising:
hosting an electronic funds transfer-based (EFT-based) payment module for a service provider;
storing a payment agreement data between a person having a financial obligation to a service provider and the service provider in a database; and
effectuating at least one payment via an electronic funds transfer (EFT), whereby a first account of the person is debited and currency is deposited in a second account of the service provider.

22. The system of claim 21, wherein the first account is a health savings account (HSA).

23. The system of claim 21, wherein the service provider is a provider of medical services and the person is receiving medical services.

24. The system of claim 23, wherein effectuating at least one payment occurs prior to the completion of the medical services the person is receiving.

25. The method of claim 21, wherein the database that the agreement data is stored into may be accessed remotely.

26. The system of claim 25, wherein the person may make payments, schedule payments, alter payments and track payments by accessing the database.

27. The system of claim 25, wherein the database that the agreement data is stored may be accessed through a graphical interface via the Internet.

28. The system of claim 21, wherein the database further houses financial and personal information of the person.

29. The system of claim 28, wherein the person can view and alter their financial and personal information by accessing the database.

30. The system of claim 21, wherein the agreement is an automated clearing house (ACH) agreement.
